(19) United States
(12) Patent Application Publication
(10) Pub. No.: US 2019/0392531 A1
(43) Pub. Date: Dec. 26, 2019

(54) SOCIAL CONNECTION RECOMMENDATION BASED ON SIMILAR LIFE EVENTS

(71) Applicant: INTERNATIONAL BUSINESS MACHINES CORPORATION, Armonk, NY (US)

(72) Inventors: Lisa Seacat DeLuca, Baltimore, MD (US); Clifford A. Pickover, Yorktown Heights, NY (US)

(21) Appl. No.: 16/018,910

(22) Filed: Jun. 26, 2018

(51) Int. Cl. G06Q 50/00

(52) U.S. Cl. CPC G06Q 50/01

(57) ABSTRACT

Embodiments of the present invention disclose a method, computer program product, and system for a social connection recommendation based on a similar order of life events. The computer may determine a plurality of life events for a user and a set of other users through an opt-in fashion. The plurality of life events for the user and the plurality of life events of the set of other users may be compared. It may be determined whether a correlation exists between the user and at least one individual from the set of other users. In response to determining the correlation exists between the user and the at least one individual from the set of other users, a recommendation may be provided to the user for a social connection between the user and the at least one individual from the set of other users.

### BACKGROUND

The present invention relates generally to the field of computing, and more particularly to recommendations for social connections.

Everyone experiences life events and has a desire to connect with people who have similar kinds of life events. The life event could be divorce, publishing a book, having a certain achievement, having a child within a particular group or demographic, graduating from college, moving to a new state, and anything else that has an effect on one's life. Many people may be interested in connecting with people who may relate to their own life stories and have similarities to their lives. The sequence in which life events happen vary from person to person. Other people may be interested in seeing the diversity of people who are different from their own lives and demographics.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for a social connection recommendation based on a similar order of life events. The computer may determine a plurality of life events for a user and a set of other users. The plurality of life events for the user and the plurality of life events for the set of other users may be obtained through an opt-in fashion. The plurality of life events for the user and the plurality of life events of the set of other users may be compared. It may be determined whether a correlation exists between the user and at least one individual from the set of other users. In response to determining the correlation exists between the user and the at least one individual from the set of other users, a recommendation may be provided to the user for a social connection between the user and the at least one individual from the set of other users.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a functional block diagram illustrating a system for a social connection recommendation based on similar life events, in accordance with an embodiment of the present invention.

FIG. 2 is a flowchart depicting operational steps of the social connection recommendation based on similar life events of FIG. 1, in accordance with an embodiment of the present invention.

FIG. 3 illustrates an example a scenario, where the present invention can be implemented.

FIG. 4 is a block diagram of components of a computing device of the system for the social connection recommendation based on similar life events of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to recommendations for social connections. The following described exemplary embodiments provide a system, method, and program for, among other things, a social connection recommendation based on similar life events. Therefore, the present invention has the capacity to improve the technical field of computer functionality by more efficiently connecting users with new acquaintances that may or may not be human.

As previously described, everyone experiences life events and has a desire to connect with people who have similar kinds of life events. The life event could be divorce, publishing a book, having a certain achievement, having a child with autism, graduating from college, moving to a new state, and anything else that has an effect on one's life. Many people may be interested in connecting with people who may relate to their own life stories and have similarities to their lives. Other people may be interested in seeing the diversity of people who are different from their own lives and demographics.

Recommendation systems are information filtering systems that seek to predict the rating or preference that a user would give to an item. Recommender systems are popular in the fields of movies, music, news, books, research articles, search queries, social tags, general products, expert collaborators, jokes, restaurants, garments, financial services, life insurance, romantic partners, and social media, for example Twitter® (Twitter and all Twitter-related trademarks and logos are trademarks or registered trademarks of Twitter Inc. and/or its affiliates) pages. There are many matchmaking sites available, however, they require people to fill out surveys and personality tests. These approaches do not make use of automated feeds of livestream events. Analysis of life events is different from assessing personality, which uses the Myers-Briggs test. The Myers-Briggs test has little power in predicting how happy someone will be in a certain situation, how successful someone would be with a certain job or role, or happy someone would be in a certain relationship. As such, it may be advantageous to, among other things, implement a system for social connection recommendations that is capable of being direct and automated.

According to one embodiment, a recommendation may be made to a user for a social connection based on similar life events. The system for the social connection recommendation based on similar life events may allow users to make a connection through a direct and automated system. The system may obtain a sequence of life events of a user through an opt-in fashion such as social networks, resumes, biographies, user profiles, and other forms. The sequence of life events may be obtained through an opt-in fashion from a group of individuals. The group of individuals could be users in a group, people participating in a discussion board, members of a user's social network, a family, or other such groups. A sequence of life events for a set of other users may be obtained through an opt-in fashion. The set of other users can be people who opt-in to this service, employees of a company, members of a company's support forum, members of public social networks, members of dating communities, members of branded communities, or other such people. The set of other users may also contain a fictional or historic person. A comparison may be made between the sequence of life events of the user and the sequence of life events of the set of other users. The system then may determine whether there is a correlation based on similarities or differences. Upon making a determination of the correlation, the system may present the recommendations to the user. In order to improve the system for future recommendations, user feedback may be solicited and stored in a repository.

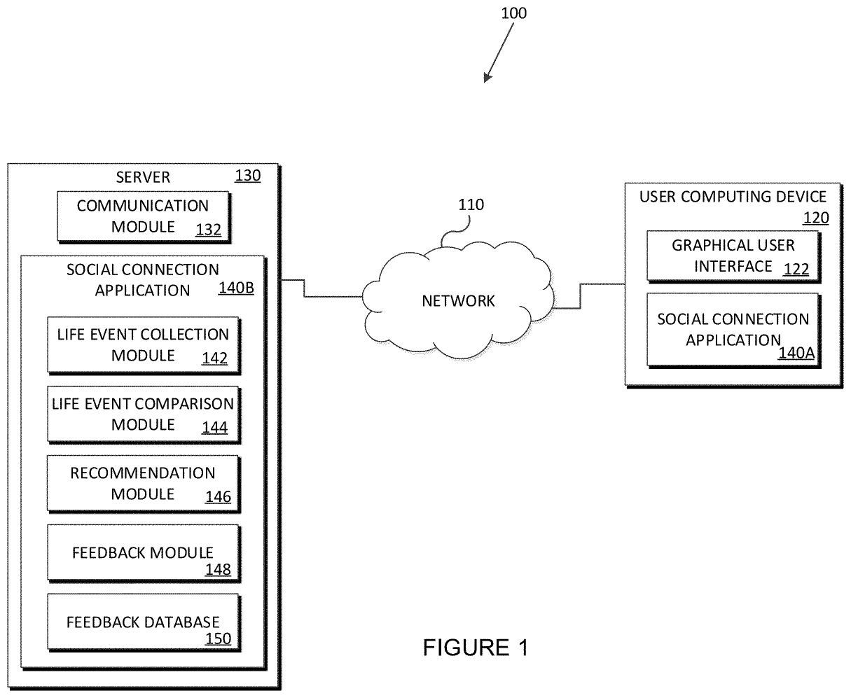

FIG. 1 is a functional block diagram illustrating a system for a social connection recommendation based on similar life events 100, in accordance with an embodiment of the present invention.

The system for the social connection recommendation based on similar life events 100 may include a user computing device 120 and a server 130. The user computing device 120 and the server 130 are able to communicate with each other, via a network 110.

The network 110 can be, for example, a local area network (LAN), a wide area network (WAN) such as the Internet, or a combination of the two, and can include wired, wireless, or fiber optic connections. In general, the network 110 can be any combination of connections and protocols that will support communications between the user computing device 120 and the server 130, in accordance with one or more embodiments of the invention.

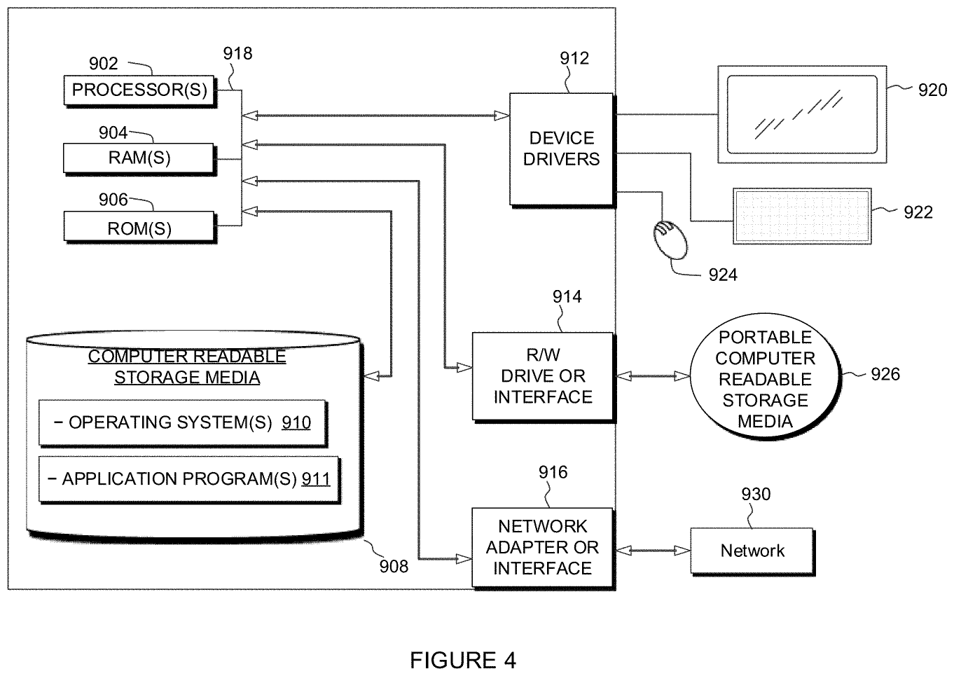

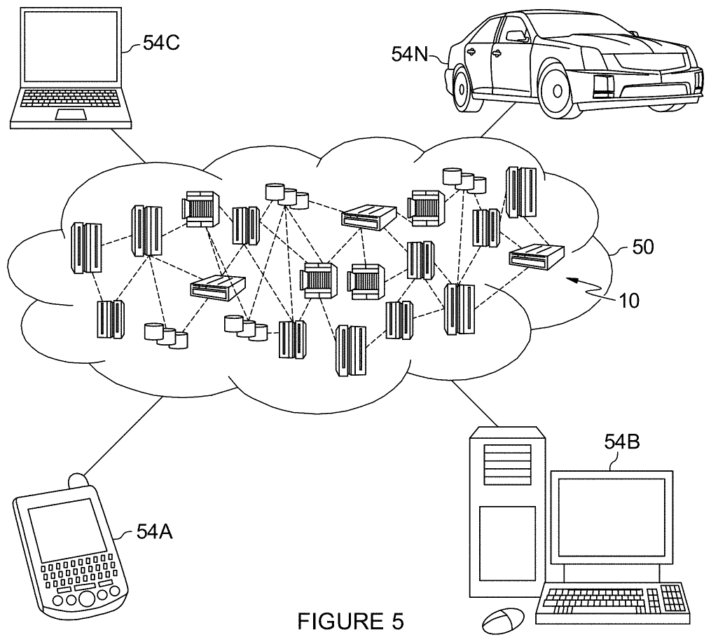

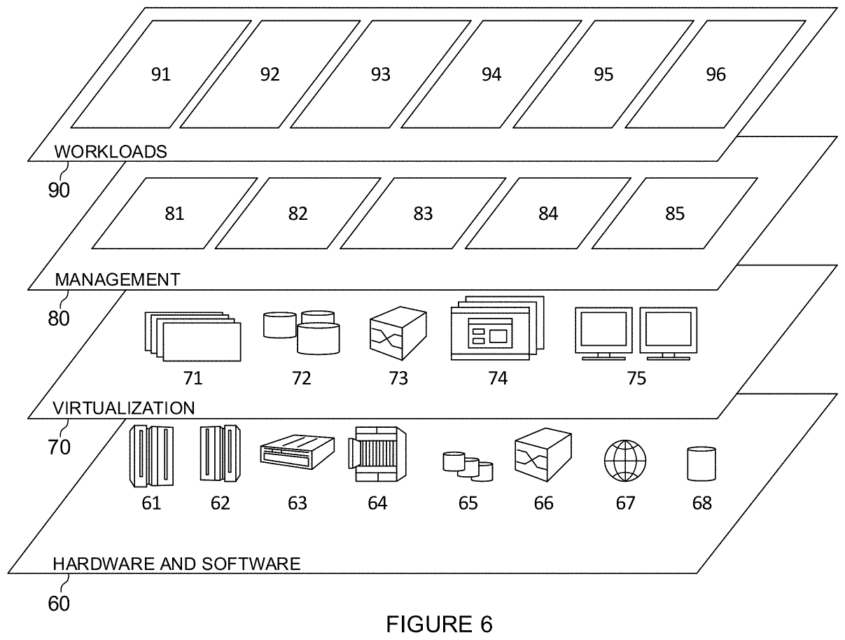

The user computing device 120 may be any type of computing device that is capable of connecting to the network 110, for example, a laptop computer, tablet computer, netbook computer, personal computer (PC), a desktop computer, a smart phone, or any programmable electronic device supporting the functionality required by one or more embodiments of the invention. The user computing device 120 may include internal and external hardware components, as described in further detail below with respect to FIG. 4. In other embodiments, the server 130 may operate in a cloud computing environment, as described in further detail below with respect to FIG. 5 and FIG. 6.

The user computing device 120 may represent a computing device that may include a user interface, for example, a graphical user interface 122. The graphical user interface 122 can be any type of application that contains an interface to view and interact with a recommendation from a recommendation module 146 and to leave feedback for a feedback module 148. The graphical user interface 122 can also contain an interface to select user preferences that may be transmitted to a life event collection module 142. The user computing device 120 may also contain a social connection application 140A.

The server 130 may include a communication module 132 and a social connection application 140B. The server 130 is able to communicate with the user computing device 120, via the network 110. The server 130 may include internal and external hardware components, as depicted and described in further detail below with reference to FIG. 4. In other embodiments, the server 130 may operate in a cloud computing environment, as depicted in FIG. 5 and FIG. 6.

The communication module 132 is capable of communicating between the user computing device 120 and the social connection application 140A, 140B. The communication module 132 may transmit user preferences from the user computing device 120 to the life event collection module 142 and user feedback from the user computing device 120 to the feedback module 144. Furthermore, the communication module 132 may transmit a recommendation from the recommendation module 146 to the user computing device 120.

The social connection application 140A, 140B may host the life event collection module 142, a life event comparison module 144, the recommendation module 146, the feedback module 148, and a feedback database 150. The social connection application 140A, 140B may exist, either wholly or in part, on either the user computing device 120 or the server 130 or on both the user computing device 120 and on the server 130.

The life event collection module 142 may receive a user preference from the user computing device 120, via the communication module 132. The life event collection module 142 may then obtain life events through an opt-in fashion such as from social networks, resumes, webpages, biographies, user profiles, and other forms with the user's permission. Additionally, the life event collection module 142 may obtain life events from fictional or historical people, such as from a book. Furthermore, the life event collection module 142 may transmit the sequence of life events obtained to the life event comparison module 144.

The life event comparison module 144 may receive sequences of life events from the life event collection module 142. Life events may include a user's location, city, state of birth, occupation, demographic, culture, relationship changes, social status, working hard through schooling, becoming a successful business person, dealing with diseases or syndromes, family members with diseases or syndromes, overcoming adversity, and other such events. The life event comparison module 144 may compare the sequence of life events of a user or group of individuals to the sequence of life events of a set of other users. The sequences of life events may be analyzed in terms of the order of events, the proximity or distance of events in time, the proximity of events in space, the proximity of events in terms of emotional impact, the repeated events or themes in one's life or other such characteristics. The life event comparison module 144 may perform standard methods that parse dates, order of events, and key words. Topics may be extracted using latent semantic indexing and related methods. Furthermore, the life event comparison module 144 may find complementary and orthogonal people or groups. After the comparison is made, the life event comparison module 144 may transmit the results to the recommendation module 146.

The recommendation module 146 may receive the results of the comparison performed by the life event comparison module 144. The recommendation module 146 may determine whether a recommendation should be made. A recommendation can be in the form of suggestions for people or groups, establishing a phone call between one or more parties, establishing an instant message connection between one or more parties, signing up a person for a group, sending a tweet on Twitter®, exposing a user to a Slack® (Slack and all Slack-related trademarks and logos are trademarks or registered trademarks of Slack Technologies and/or its affiliates) team, following a person on a social network, and other such forms. The recommendation may also include a percentage of similarity, a list of common connections, a list of dates associated with a similar life events, an order of life events, a list of specific similar life events, and a list of specific dissimilar life events in order to describe the correlation between the user and the recommended user(s). The recommendation module 146 transmits the recommendation to the user computing device 120, via the communication module 132.

The feedback module 148 may determine whether the user wants to leave feedback for the system. When a user wants to leave feedback, the feedback module 148 may collect the feedback through user input methods, such as keyboard entry or mouse click recording. The feedback collected may enable the social connection application 140A, 140B to learn from a user's response and be able to generate a more precise recommendation. Furthermore, the feedback module 148 may transmit the feedback to the feedback database 150 to be stored.

The feedback database 150 may be a data store that may store feedback received from the feedback module 148. The feedback stored by the feedback database 150 may be used by the social connection application 140A, 140B.

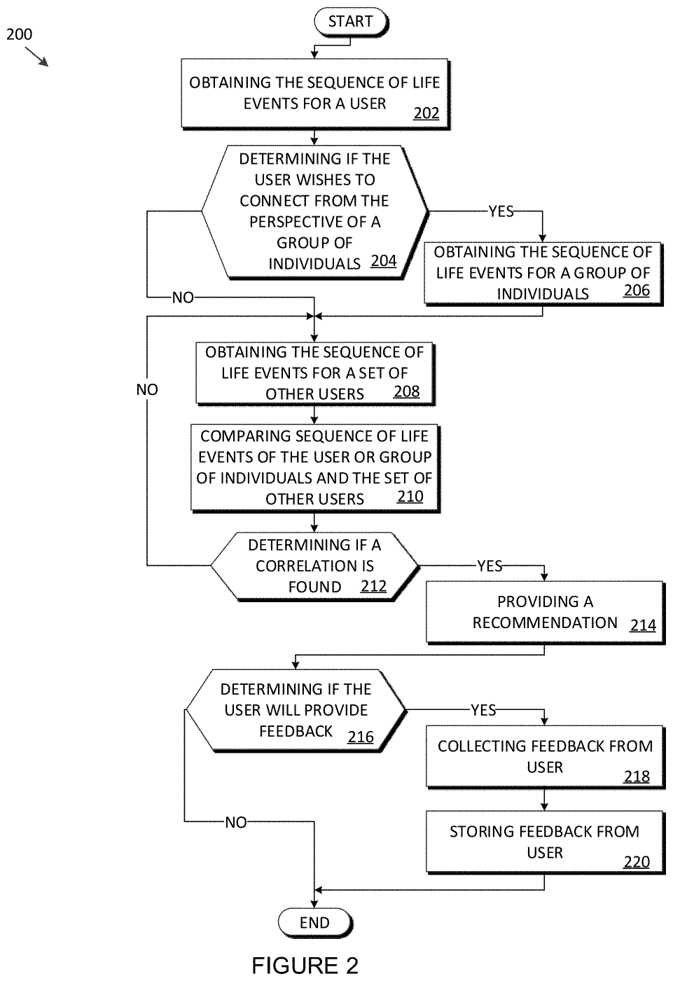

FIG. 2 depict an operational flowchart 200 illustrating the social connection recommendation based on similar life events. At 202, the life event collection module 142 obtains the sequence of life events for a user. The life event collection module 142 may receive the identity of the user from the user computing device 120, via the communication module 132. The life event collection module 142 may obtain the users sequence of life events through an opt-in fashion where the user has given permission. The opt-in fashion may be from social networks, such as Facebook® (Facebook and all Facebook-related trademarks and logos are trademarks or registered trademarks of Facebook Inc. and/or its affiliates), LinkedIn® (LinkedIn and all LinkedIn-related trademarks and logos are trademarks or registered trademarks of LinkedIn Corporation and/or its affiliates), Twitter®, or other social networks, resumes, webpages, biographies, user profiles, and other such forms. Life events collected may be a user's location, city, state of birth, occupation, demographic, culture, relationship change, such as, marriage or divorce, social status, such as, born to a poor family, working hard through schooling, becoming a successful business person, dealing with disease or syndromes, having family members with diseases or syndromes, and other such events. Standard methods to parse dates, order of events, and key words may be used to obtain life events along with topic extraction using latent semantic indexing or other related methods. The life event collection module 142 may transmit the sequence of life events of the user to the life event comparison module 144. For example, the sequence of life events from a user may be obtained from a combination of their Facebook® profile and their resume.

Then, at 204, the life event collection module 142 determines whether the user wishes to connect from the perspective of a group of individuals. The user may indicate on the user computing device 120 whether they wish to interact or make a connection with a person or group related to life events of their friends, family, or other such group and not just of themselves. The group of individuals may be any group, people participating in a discussion board, members of a user's social network who use Facebook®, LinkedIn®, Twitter®, or other social networks, or a family. The indication may be transmitted from the user computing device 120 to the life event collection module 142, via the communication device 132. For example, the user may wish to connect with people who have had similar life events to their extended family, in order to better understand what they might be going through.

Next, at 206, when it is determined that the user wishes to connect from the perspective of a group of individuals, the life event collection module 142 obtains the sequence of life events for the group of individuals. Based on the user's indication, the life event collection module 142 may obtain the sequence of life events for each of the members of the group of individuals through an opt-in fashion. The opt-in fashion may be from social networks, such as Facebook®, LinkedIn®, Twitter®, or other social networks, resumes, webpages, biographies, user profiles, and other such forms where the user has given permission. The life events collected may be a user's location, city, state of birth, occupation, demographic, culture, relationship change, such as marriage or divorce, social status, such as born to a poor family, working hard through schooling, becoming a successful business person, dealing with disease or syndromes, having family members with diseases or syndromes, and other such events. Life events obtained may be for a historical or fictional person. Standard methods to parse dates, order of events, and key words may be used to obtain life events along with topic extraction using latent semantic indexing or other related methods. The life event collection module 142 may transmit the sequence of life events of the group of individuals to the life event comparison module 144. For example, the extended family's life events could be obtained from a combination of Facebook® posts and a blog.

Then, at 208, when it is determined that the user does not wish to connect from the perspective of a group of individuals, the life event collection module 142 obtains the sequence of life events for a set of other users. When it is determined that the user wishes to connect from the perspective of a group of individuals and the life event collection module 142 has obtained the sequence of life events for the group of individuals, the life event collection module 142 may obtain the sequence of life events for the set of other users. The set of other users may be set of users that have both similar and dissimilar life events, people who opt-in to the service, employees of a company, members of a company's support forum, members of public social networks, members of dating communities, members of branded communities, and other such people. The sequence of life events of the set of other users may be obtained by obtaining the sequence of life events for both complementary and orthogonal people. Life events obtained may be for a historical or fictional person. The sequence of life events for the set of other users may be transmitted to the life event comparison module 144. For example, the life event collection module 142 obtains the sequence of life events for all members of the company's support forum as the set of other users.

Next, at 210, the life event comparison module 144 compares the sequence of life events of the user or group of individuals and the set of other users. The life event comparison module 144 may perform the comparison in order to determine any correlation found between users. The sequence of life events may be analyzed in terms of order of life events, proximity of life events, proximity of events in space, proximity of life events in terms of emotional impact, repeated events or themes in one's life, and other such terms. The life event comparison module 142 may transmit the results of the comparison to the recommendation module 146. For example, the life events of the user may be compared to the life events of their co-workers.

Then, at 212, the recommendation module 148 determines whether a correlation is found. The correlation could be a match for similar life events but it could also be a match for dissimilar life events. The user should be given the option to connect with someone who has had similar life events but also the option to connect with someone who has had dissimilar life events so that they can get a diversity of thoughts and opinions. When the recommendation module 146 does not find a correlation, the life event collection module 142 may obtain the sequence of life events for a new set of other users. For example, a user has had a very obscure order of life events and the recommendation module 146 does not find a close comparison for either similar or dissimilar events. The life event collection module 142 may broaden the set of other users to be searched from.

Next, at 214, when the recommendation module 148 determines that a correlation has been found, the recommendation module 148 provides a recommendation. The trigger of a social recommendation can take the form of a suggestion for people or groups to send an email, an instant message, or other such communication, establishing a phone call between one or more parties, establishing an instant message connection between one or more parties, signing up a person for a group, sending a tweet on Twitter®, exposing a user to a Slack® channel, following a person on Twitter® or LinkedIn®, or other such forms. The recommendation may also include a percentage of similarity, a list of common connections, a list of dates associated with a similar life events, an order of life events, a list of specific similar life events, and a list of specific dissimilar life events in order to describe the correlation between the user and the recommended user(s). The recommendation module 146 may transmit the recommendation to the user computing device 120, via the communication module 132. The graphical user interface 122 of the user computing device 120 may display an interface with the icons of the set of other users. A color frame may be around each icon where green may represent a similarity and yellow may represent a difference. For example, the recommendation module 146 may find a user who went to the same school and works for the same company but lives in a different area than the user. The user may wish to connect with this user via email.

Then, at 216, the feedback module 148 determines whether the user will provide feedback. The feedback module 148 may transmit a feedback request to the user computing device 120, via the communication module 132. The feedback request may be optional but may be used to enable learning from a user's delight with the recommendations provided. For example, the feedback module 148 may ask the user whether they were satisfied with the recommendations provided.

Next, at 218, when the feedback module 148 determines that the user will provide feedback, the feedback module 148 collects the feedback from the user. After the feedback module 148 has asked for feedback, the users response may be transmitted to the feedback module 148 from the user computing device 120, via the communication module 132. The feedback module 148 may transmit the feedback to the feedback database 150 to be stored. For example, the user could respond that they were highly satisfied with the recommendations provided.

Then, at 220, the feedback database 150 stores the feedback from the user. The feedback database 150 may receive feedback from the feedback module 148. The stored feedback may be used to teach the social connection application 140A, 140B based on the satisfaction or dissatisfaction of the user with the recommendations. The feedback may also be used to generate more precise recommendations as well as to unlearn stale preferences or input events that may be based on regions of a person's life that actually do not interest a person. For example, a user may be dissatisfied by a recommendation because it was focused on similarities to the city the user was born in, however, the user only lived there for 6 months and does not remember a thing about it.

It may be appreciated that FIG. 2 provides only an illustration of one implementation and does not imply any limitations with regard to how different embodiments may be implemented. Many modifications to the depicted environments may be made based on design and implementation requirements. For example, in at least one embodiment, the recommendation module 146 may present an artificial intelligence personage to connect with the user. The simulated individual may share similar life experiences with the user.

Additionally, when identifying potential individuals with whom to connect based on life events, the individuals may be assessed based on various measures of centrality of the individuals in a social network. In graph theory and network analysis, indicators of centrality identify the most important vertices within a graph. For example, a user may wish to interact with someone with a certain value of social connectivity (e.g., a social influencer) and the user may even wish to pay a price for such access. Such measures of social-network centrality may include betweenness centrality, closeness centrality, eigenvector centrality, degree centrality, harmonic centrality, and Katz centrality of the same graph.

Furthermore, a user may desire to connect with individuals who not only has similar experiences, such as divorce or retirement, but also individuals with a certain social-network characteristic, such as being influential, well connected, or being a hub or authority relating to certain life experiences or events.

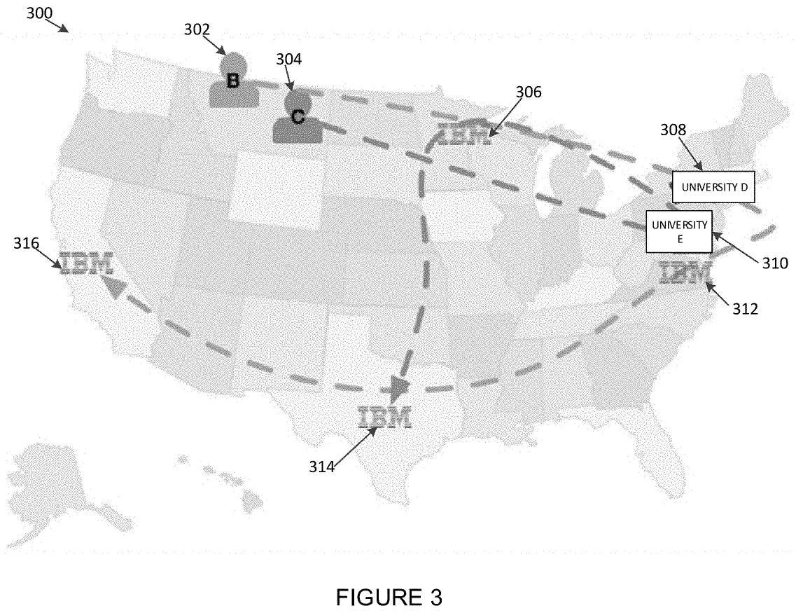

FIG. 3 illustrates a functional block diagram 300 where the present invention can be used. In the scenario depicted, user B 302, user C 304, life event 306, university D 308, university E 310, life event 312, life event 314, and life event 316 may all be important elements. User B 302 may have been recently hired at IBM® (IBM and all IBM-related trademarks and logos are trademarks or registered trademarks of International Business Machines Corporation and/or its affiliates) as a full-time employee, which is depicted as life event 316. Upon starting employment at IBM®, user B 302 may begin looking for a mentor within IBM® to help him navigate his career. User B 302 may use the social connection application 140A, 140B in order to find a mentor that he has a close personal connection to. The life event collection module 142 may collect the sequence of life events of user B 302 as described in step 202. The life event collection module 142 may find that user B 302 grew up in Montana before going to University D 308. User B 302 also had an internship with IBM®, which is depicted as life event 312. The life event collection module 142 may then collect the sequence of life events for all IBM® employees. The life event comparison module 144 may compare the sequence of life events of user B 302 to the sequence of life events of other IBM® employees in order to find a correlation. The life event comparison module 144 may find that User C 304 has a similar sequence of life events to User B 302. User C 304 may have also grown up in Montana, went to University E 310 which was in the same city as University D 308, and had an internship with IBM®, which is depicted as life event 306. Now User C 304 has a full-time job with IBM®, which is depicted as life event 314. Based on this information, the recommendation module 146 may recommend a connection with User C 304 to User B 302.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

FIG. 4 depicts a block diagram of components of the user computing device 120 of the system for a social connection recommendation based on similar life events 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The user computing device 120 and/or the server 130 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the social connection application 140A, 140B (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The user computing device 120 and/or the server 130 may also include a R/W drive or interface 914 to read from and write to one or more portable computer readable storage media 926. Application programs 911 on the user computing device 120 and/or the server 130 may be stored on one or more of the portable computer readable storage media 926, read via the respective R/W drive or interface 914 and loaded into the respective computer readable storage media 908.

The user computing device 120 and/or the server 130 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the user computing device 120 and/or the server 130 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The user computing device 120 and/or the server 130 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and social connection recommendation 96. Social connection recommendation 96 may relate to receiving a sequence of life events for multiple users and determining whether a correlation exists. When it is determined that a correlation exists, the social connection recommendation 96 may provide a recommendation to the user.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for a social connection recommendation based on a similar order of life events, the method comprising:
determining, by a computer, a plurality of life events for a user and a set of other users, wherein the plurality of life events for the user and the plurality of life events for the set of other users are obtained through an opt-in fashion;
comparing the plurality of life events for the user and the plurality of life events of the set of other users;
determining whether a correlation exists between the user and at least one individual from the set of other users; and
in response to determining the correlation exists between the user and the at least one individual from the set of other users, providing a recommendation to the user for a social connection between the user and the at least one individual from the set of other users.

2. The method of claim 1, further comprising:
determining whether the user wishes to connect from a perspective of a group of individuals instead of from a perspective of the user, wherein the group of individuals is selected from a group consisting of a common interest group, a plurality of people in a discussion board, a plurality of people of a social network, and a family.

3. The method of claim 2, further comprising:
in response to the user wishing to connect from the perspective of the group of individuals instead of from the perspective of the user, receiving a plurality of life events for the group of individuals to be compared to the plurality of life events of the set of other users.

4. The method of claim 1, further comprising:
parsing the plurality of life events for the user and the plurality of live events for the set of other users for a plurality of dates, an order of events, and a plurality of key words.

5. The method of claim 1, wherein the set of other users is selected from a group consisting of a plurality of humans, a plurality of historical personages, a plurality of fictional personages, and a plurality of artificial intelligence personages.

6. The method of claim 1, wherein the recommendation includes a plurality of evidence including a percentage of similarity, a list of similar connections, a list of dates associated with a plurality of similar life events, an order of life events, a list of specific similar life events, and a list of specific dissimilar life events in order to describe the correlation between the user and the at least one individual from the set of other users.

7. The method of claim 1, further comprising:
collecting a plurality of feedback from the user, wherein the plurality of feedback indicates a level of satisfaction of the user with the recommendation; and
storing the plurality of feedback from the user, wherein the plurality of feedback is used to improve a plurality of future recommendations.

8. A computer program product for a social connection recommendation based on a similar order of life events, the computer program product comprising:
one or more non-transitory computer-readable storage media and program instructions stored on the one or more non-transitory computer-readable storage media capable of performing a method, the method comprising:
determining, by a computer, a plurality of life events for a user and a set of other users, wherein the plurality of life events for the user and the plurality of life events for the set of other users are obtained through an opt-in fashion;
comparing the plurality of life events for the user and the plurality of life events of the set of other users;
determining whether a correlation exists between the user and at least one individual from the set of other users; and
in response to determining the correlation exists between the user and the at least one individual from the set of other users, providing a recommendation to the user for a social connection between the user and the at least one individual from the set of other users.

9. The computer program product of claim 8, further comprising:
determining whether the user wishes to connect from a perspective of a group of individuals instead of from a perspective of the user, wherein the group of individuals is selected from a group consisting of a common interest group, a plurality of people in a discussion board, a plurality of people of a social network, and a family.

10. The computer program product of claim 9, further comprising:
in response to the user wishing to connect from the perspective of the group of individuals instead of from the perspective of the user, receiving a plurality of life events for the group of individuals to be compared to the plurality of life events of the set of other users.

11. The computer program product of claim 8, further comprising:
parsing the plurality of life events for the user and the plurality of live events for the set of other users for a plurality of dates, an order of events, and a plurality of key words.

12. The computer program product of claim 8, wherein the set of other users is selected from a group consisting of a plurality of humans, a plurality of historical personages, a plurality of fictional personages, and a plurality of artificial intelligence personages.

13. The computer program product of claim 8, wherein the recommendation includes a plurality of evidence including a percentage of similarity, a list of similar connections, a list of dates associated with a plurality of similar life events, an order of life events, a list of specific similar life events, and a list of specific dissimilar life events in order to describe the correlation between the user and the at least one individual from the set of other users.

14. The computer program product of claim 8, further comprising:
collecting a plurality of feedback from the user, wherein the plurality of feedback indicates a level of satisfaction of the user with the recommendation; and
storing the plurality of feedback from the user, wherein the plurality of feedback is used to improve a plurality of future recommendations.

15. A computer system for a social connection recommendation based on a similar order of life events, the computer system comprising:
one or more computer processors, one or more computer-readable storage media, and program instructions stored on one or more of the computer-readable storage media for execution by at least one of the one or more processors capable of performing a method, the method comprising:
determining, by a computer, a plurality of life events for a user and a set of other users, wherein the plurality of life events for the user and the plurality of life events for the set of other users are obtained through an opt-in fashion;
comparing the plurality of life events for the user and the plurality of life events of the set of other users;
determining whether a correlation exists between the user and at least one individual from the set of other users; and
in response to determining the correlation exists between the user and the at least one individual from the set of other users, providing a recommendation to the user for a social connection between the user and the at least one individual from the set of other users.

16. The computer system of claim 15, further comprising:
determining whether the user wishes to connect from a perspective of a group of individuals instead of from a perspective of the user, wherein the group of individuals is selected from a group consisting of a common interest group, a plurality of people in a discussion board, a plurality of people of a social network, and a family.

17. The computer system of claim 16, further comprising:
in response to the user wishing to connect from the perspective of the group of individuals instead of from the perspective of the user, receiving a plurality of life events for the group of individuals to be compared to the plurality of life events of the set of other users.

18. The computer system of claim 15, further comprising:
parsing the plurality of life events for the user and the plurality of live events for the set of other users for a plurality of dates, an order of events, and a plurality of key words.

19. The computer system of claim 15, wherein the set of other users is selected from a group consisting of a plurality of humans, a plurality of historical personages, a plurality of fictional personages, and a plurality of artificial intelligence personages.

20. The computer system of claim 15, wherein the recommendation includes a plurality of evidence including a percentage of similarity, a list of similar connections, a list of dates associated with a plurality of similar life events, an order of life events, a list of specific similar life events, and a list of specific dissimilar life events in order to describe the correlation between the user and the at least one individual from the set of other users.
